(19) United States
(12) Patent Application Publication
(10) Pub. No.: US 2001/0045737 A1
(43) Pub. Date: Nov. 29, 2001

(54) Personal portable medical records organizer

(76) Inventor: Matthew G. Hudkins, New Orleans, LA (US)

Correspondence Address: Gregory S. Rosenblatt, Intellectual Property Law Section, WIGGIN & DANA, One Century Tower, New Haven, CT, 06508-1832, US

(21) Appl. No.: 09/790,055

(22) Filed: Feb. 21, 2001

Related U.S. Application Data
(60) Provisional application No. 60/185,289, filed on Feb. 28, 2000.

(51) Int. Cl. B42F 13/00; B42F 21/00

(52) U.S. Cl. 283/38

(57) ABSTRACT

The present invention discloses and claims a portable medical records organizer having a transportable binder for personal use by a consumer. The binder holds a number of dividers that separate and organize the medical records into predetermined categories. At least one of the predetermined categories separates a record of the consumer's personal medical biographical information. Additional dividers provide for organizing and separating medical records into additional categories. A consumer may take the transportable binder from one health care provider to another thus aiding in treatment by providing the health care provider with an historical medical record.

### CROSS REFERENCE TO RELATED APPLICATION

This patent application claims priority to commonly owned U.S. Provisional Patent Application Serial No. 60/185,289 entitled “H-Files” that was filed on Feb. 28, 2000 and which is incorporated herein by reference in its entirety.

### TECHNICAL FIELD

The present invention relates generally to file organizers. More specifically, the present invention relates to a transportable device for organization of personal medical records.

### BACKGROUND OF THE INVENTION

When people establish new residences they also require new health care professionals. When traveling for pleasure or business a person may meet with a medical emergency and require the services of an unknown health care professional. These professionals would be aided if they had easy access to the patient's medical history.

The patient's medical history includes biographical data including family medical history. The results of medical tests such as X-rays, MRIs, blood tests, cardiograms, to name but a few, may alert a health care professional to a problem. This is especially true when the test results only indicate a pattern when viewed over long periods of time.

Unfortunately, the data is neither readily available nor accessible. A new health care professional would have to contact each of the patient's prior health care providers. This is both prohibitively costly, time consuming, and likely to result in less than desired results. Many prior providers may be out of business, have relocated themselves, or just unwilling to search through possibly ancient records. A patient transferring from one hospital to another may not have transferred their medical records. Further, some hospitals erroneously consider a patient's original medical record to be hospital property and are reluctant to allow even copies of the information out of their control.

Even when some of the prior providers make the records available, there may be a long delay from contact to reply to delivery of the information. Mailing records takes days; faxing takes hours to days; almost every method is complicated by middlemen with possible human error, and is subject to equipment failure or possible intercept.

The result is that health care providers lose valuable time waiting for medical records to be transferred from prior providers, and the information may be needed immediately to begin treatment. In addition, providers who see patients with whom they are not entirely familiar often need to see what other physicians have already done for the patient so as not to duplicate the efforts at the patient's discomfort and expense.

It is reasonable to expect this situation to deteriorate with increases in specialists and HMO's. The more that medical care is fragmented among specialists the greater the need there is to have easily transferable records. HMOs also fragment the medical record when there is change in a patient's coverage plan, the patient moves, their doctor retires or moves, or the patient is traveling.

Concerned patients avoid the problem of medical record transfer by transporting copies or originals of their records themselves. These patients may bring their records with them to other hospitals, clinics, doctors, etc. Without an understanding of the records or their relationship to one another, the copies often become disorganized and out-of-order. Further, certain records, such as X-rays, lack adequate protection from damage.

Medical record holders currently available are inadequate for the tasks listed above. These record holders focus on organization and storage of patients' in-hospital records once that patient is already hospitalized. More importantly, the record holders are the property of the hospital, are designed to stay in the hospital, use hospital-owned original medical records, are emptied out and reused with each patient newly admitted to the hospital, and are not the property of the individual user.

Therefore, there is a need for a health care consumer to have a way to organize his or her medical records in a personal records transporter, in control of, owned, and carried by the consumer, so that the records may be transported from health care provider to health care provider.

U.S. Pat. No. 5,452,808 to Abramowitz discloses a portable patient medical record holder having a color-coded system for holding folders and designed for use within a hospital. The holder has slots into which folders may be placed. Markings on the folders are the same as markings on the holder.

U.S. Pat. No. 2,713,531 to Boone discloses a filing cabinet which can contain multiple filing folders. The cabinet holds clipboards in slotted rows. Each clipboard is identified with the nature of the information held by the clipboard.

U.S. Pat. No. 3,472,387 to Olsen discloses a portable hospital record chart holder apparatus with a wheel-bearing frame that includes means for supporting hospital record charts vertically. Also provided are bars to hold the charts in place and keep them from clanging. The chart holder is mounted on rollers to make it portable.

U.S. Pat. No. 4,041,893 to Mulloy discloses a chart for use in hospitals or nursing homes and indicating the next procedure to be taken in the continuing care of a patient. Various linear and one rotary indicator is operable to indicate the time and nature of a particular procedure.

U.S. Pat. No. 4,865,549 to Sonsteby discloses a documentation system that includes a plurality of sections, each dedicated to a particular body system. Each section has a plurality of peel-off labels, each providing a series of assessment steps. Each label has a distinctive color associated with a particular section, with the text also associated in distinctive color.

U.S. Pat. Nos. 5,452,808 and 4,865,549 are incorporated herein by reference in their entirety.

### BRIEF SUMMARY OF THE INVENTION

The problems and limitations of the existing state of the art are overcome by the present invention. The present invention discloses and claims a portable medical records organizer having a transportable binder for personal use by a consumer. The binder holds a number of dividers that separate and organize either copies or originals of the medical records into predetermined sections. At least one of the dividers is used to establish a category for the consumer's personal medical biographical information. Additional dividers provide for organizing and separating medical records into predetermined categories and at the same time provide helpful instructions on acquiring the personal records from health care providers.

### BRIEF DESCRIPTION OF THE DRAWINGS

The present invention will now be described, by way of example only, with reference to the accompanying drawings in which:

FIG. 1 illustrates a completed assembly of the present invention.

FIG. 2 illustrates a binder of the present invention; and

FIG. 3 illustrates a representative divider with an optional tab and printed instructions.

Like reference numbers and designations in the various drawings depict like elements.

### DETAILED DESCRIPTION

The present invention discloses and claims an apparatus and method for patients to obtain copies of their personal medical records, organize the records into specific sections based on content of the records, and enable the patient to transport the organized copies of the medical records. The organized records, being either originals or copies thereof, are stored in a binder to allow convenient transport of the records. Such personalized transport of copies of one's medical records provides health care providers with immediate access to records from the patient's prior health care providers.

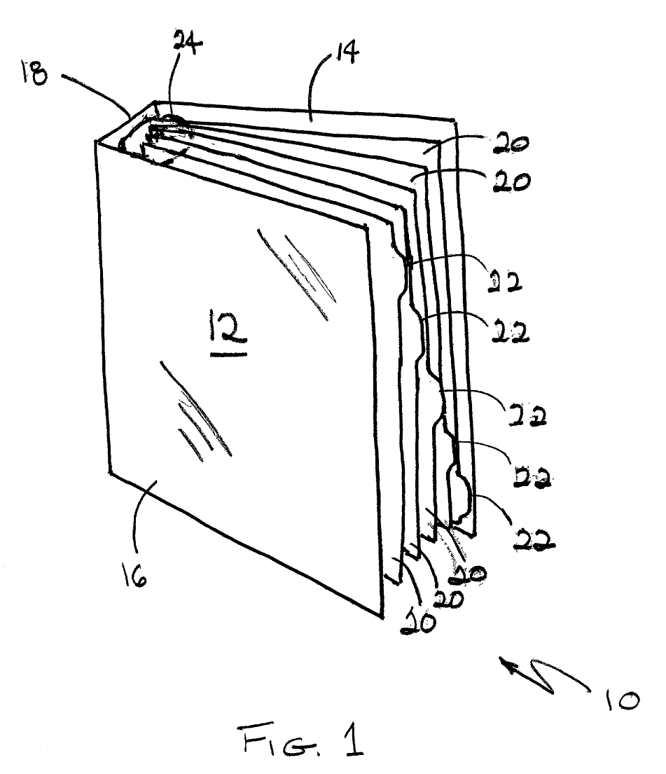

FIG. 1 illustrates a portable personal medical record holder 10 in accordance with the present invention. Record holder 10 is comprised of a binder 12. Binder 12 may be of any desired color and proportion. Binder 12 has a front cover 14, back cover 16, and spine 18.

In a preferred embodiment binder 12 is sized so as to cover completely standard 8½ by 11 sheets of paper. Binder 12 may be assembled from the inexpensive, inflexible, plastic-covered cardboard variety, available in a variety of colors. However, the present invention is not limited by the type of binder selected. It is considered that there may be gradations of binder quality to appeal to consumer preferences. The outer covers may be plain and unlabeled, or they may have a product logo or any other desired markings.

Record dividers 20 are used to separate personal medical records into predetermined categories. Record dividers 20 may be sized to be substantially the same size as the anticipated medical records. However, this is not a limitation. It is contemplated that the dividers may be color coded to ease and coordinate identification of the medical records. In this way medical records can be marked with a similar color so that the user may easily identify a particular record with its preferred category.

In a preferred embodiment, record dividers 20 have tabs 22. These tabs are marked with predetermined categories of medical records. A non-limiting list of categories includes Biography, History & Physical, Discharge Summaries, Labs, Radiology/Pathology, Rehab/Diet/Nutrition, Vaccinations/Medications, Psychiatry, and Miscellaneous. Tabs 16 may be integral with record divider 14 or separable.

A divider retainer 24 engages record dividers 20 and secures record dividers 20 within binder 12. Divider retainer 24 may also be employed to engage the medical records. In a preferred embodiment divider retainer 24 is comprised of rings operable to open for insertion through holes in record dividers 20. Mechanisms using spring pressure as well as others for retaining the dividers are known to those of ordinary skill in the art and may be employed without altering the inventive concept of the present invention.

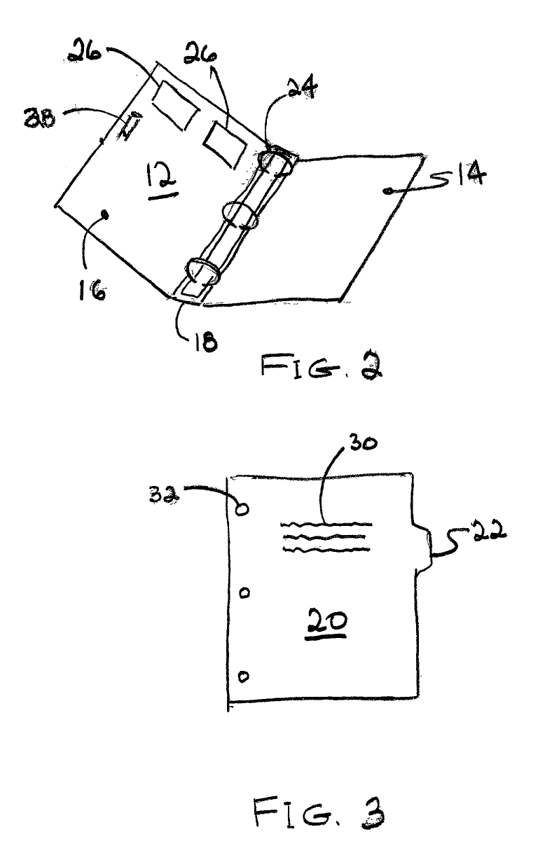

FIG. 2 illustrates binder 12 for the medical record holder of the present invention. Back cover 14, front cover 16, and spine 18 comprise binder 12. Divider retainer 24 is mounted on spine 18.

In a preferred embodiment divider retainer 24 is a made of operable rings that open to accept record dividers which are adapted to fit over the operable rings. The rings are closed thereby securing the dividers within binder 12. While three rings are illustrated any number are within the ambit of the invention. The rings may be of various sizes depending on the number of pages desired for retention.

The inside of front cover 16 may contain pockets 26, preferably formed of plastic. Pockets 26 are approximately 2″ by 4″, or big enough to securely hold business cards of health care providers. Of course, pockets 26 may also serve desired alternative purposes which may be conceived of by the user. It is contemplated that other useful attachments such as a penholder 28 may be added to binder 12.

FIG. 3 illustrates record divider 20. It is contemplated that record dividers 20 will be available in several colors as described herein above. In the preferred embodiment record dividers 20 have pre-punched holes 32 arranged and sized to fit over the rings of divider retainer 24. Pre-labeled tab 22 identifies different sections of the file. It is contemplated that at least one of dividers 20 will be blank to allow for the user to create a new category.

Each divider may be preprinted with a description of the copied medical records segregated into that section. For example, the “Medications” divider may include an instruction such as: “In this section, place any pages of the medical record containing lists of medicines you have taken or are currently taking. Be sure to include a list of medications you are currently taking, the amounts, how long you have been taking them, and how often you take them.” Other dividers may have similar instructions. It is further contemplated that additional information such as hints on acquiring the desired records may be preprinted on certain dividers or on separate sheets of paper.

It is contemplated that one divider will be preprinted with additional information such as a description of the use of the personal medical records organizer, instructions on initial set up as well as advice on ways to keep the records current, and a contact point for any questions or comments.

An additional divider is anticipated to create a category for personal biographical data. This category contains a preprinted fill-in-the-blank questionnaire for personal biographical data. The biographical data requested includes, in a non-limiting list, the user's name, address, phone number, religious affiliation (if any), name of Pastor, next of kin, etc. A blank area may be provided for any notes the user may wish to make.

A user organizes the medical records in the portable personal medical records organizer for transport between health care service providers. The personal records are acquired from as many prior or current health care providers that the user can contact. The records are gathered into the categories as indicated by the predetermined printed legends on the record dividers. The record dividers and associated personal records are combined and organized into the predetermined categories. These organized records are engaged by the record retainer into the transportable binder. While a preferred embodiment has been shown and described, various modifications and substitutions may be made thereto without departing from the spirit and scope of the invention. Accordingly, it is to be understood that the present invention has been described by way of illustration and not limitation.

1. A portable medical records organizer comprising:
a binder for personal use by a user;
a plurality of dividers adapted for retention in a divider retainer effective to separate said medical records into categories;
at least one of said dividers effective to separate said medical records into a biographical data category;
at least one preprinted biographical data sheet having areas identified wherein a user records personal medical information; and
at least one of said divider retainers, attached to said binder, operable to engage said plurality of dividers and said medical records.

2. The portable medical records organizer of claim 1 wherein said binder further comprises:
a back cover;
a front cover;
a spine connecting said front cover to said back cover; and
at least one of said front cover and said back cover having a plurality of pockets.

3. The portable medical records organizer of claim 1 wherein said divider retainer is a plurality of rings.

4. The portable medical records organizer of claim 3 wherein each of said plurality of dividers further comprise a tab, said tab being either part of said divider or attached to said divider.

5. The portable medical records organizer of claim 4 wherein:
said tab has a predetermined printed legend; and
said divider has a printed instruction related to said predetermined printed legend.

6. The portable medical records organizer of claim 5 wherein each of said plurality of dividers has a protective coating.

7. The portable medical records organizer of claim 1 wherein said divider retainer is a clamp spring loaded to captivate by pressure said dividers and said medical records.

8. The portable medical records organizer of claim 1 wherein said binder further comprises:
a locking means for making the binder resistant to opening; and
an unlocking means for making said locking means operable to allow opening of said binder.

9. A method for organizing medical records for transport by an owner between health care service providers comprising:
acquiring medical records from at least one of said heath care providers;
categorizing said medical records into a plurality of categories;
separating said medical records into said categories;
combining said identified categories of medical records; and
organizing said identified categories of medical records into a transportable binder.

10. The method of claim 9 further comprising:
recording personal biographical information on a biographical data sheet having preprinted areas wherein said owner records said personal biographical information; and
retaining said biographical data sheet in one of said categories.

11. The method of claim 9 further comprising identifying each of said categories of said medical records by a divider having a predetermined printed legend.

12. The method of claim 11 wherein said dividers comprise printing said predetermined printed legends on a tab attached to said divider.

13. The method of claim 11 further comprising:
printing on each of said dividers instructions for usage of said categories of medical records; and
printing an instruction sheet containing instructions on obtaining said medical records from said health care providers.

14. The method of claim 9 wherein said transportable binder and said medical records are the property of said owner.

15. The method of claim 9 wherein said transportable binder can be made resistant to opening by persons other than those authorized by said owner.
